(19) United States
(12) Patent Application Publication
(10) Pub. No.: US 2013/0038845 A1
(43) Pub. Date: Feb. 14, 2013

(54) OPTICAL PROJECTION SYSTEM AND LENS POSITION ADJUSTMENT MECHANISM THEREOF

(71) Applicants: Chun-Ping WANG, Hsinchu City (TW); Tzu-Tse Huang, Hsinchu City (TW); Chia-Lun Liu, Hsinchu City (TW); Tung-Yi Ko, Hsinchu City (TW)

(72) Inventors: Chun-Ping WANG, Hsinchu City (TW); Tzu-Tse Huang, Hsinchu City (TW); Chia-Lun Liu, Hsinchu City (TW); Tung-Yi Ko, Hsinchu City (TW)

(21) Appl. No.: 13/469,543

(22) Filed: May 11, 2012

(30) Foreign Application Priority Data
Aug. 11, 2011 (CN) 201110235051.9

(51) Int. Cl. G03B 21/26; F21V 17/02

(52) U.S. Cl. 353/94; 362/319

(57) ABSTRACT

An optical projection system and a lens position adjustment mechanism thereof are provided. The lens position adjustment mechanism includes a fixed cover, a lens mount, a force-exertion element, and a movable element. A pivot part of the lens mount is inserted into a pivot hole of the fixed cover so as to allow the lens mount to pivot on the fixed cover. The force-exertion element is disposed on the pivot part of the lens mount, and two ends of the force-exertion element are respectively connected to a fixed pillar of the fixed cover and a fixed part of the lens mount to force the lens mount to rotate along a first rotation direction. The movable element pushes a block part of the lens mount to force the lens mount to rotate along a second rotation direction opposite the first rotation direction.

### BACKGROUND OF THE INVENTION

1. Field of the Invention

The invention relates to a lens position adjustment mechanism and, more particularly, to a lens position adjustment mechanism used in an optical projection system.

2. Description of the Related Art

In an optical projection system, due to the manufacturing tolerance of a light bulb and the variations in the assembly precision, light spots projected by different light source modules are formed on a light-combination lens at different positions. Therefore, a lens position adjustment mechanism is needed to adjust the position of the light-combination lens to correct a deviation light path of the light source module and thus improve image qualities.

As shown in FIG. 6, Taiwan patent publication No. 200842483 has disclosed a lens adjustment element 100 having a fastening body 102 and an extension portion 104. Clip structures 108 are disposed on the fastening body 102 to secure a lens 106 on the lens adjustment element 100. A center portion of a bottom side 102a extends downwardly to form an arc edge (not numbered) on the fastening body 102. The arc edge of the bottom side 102a functions as a pivot point, and an auxiliary jig (not shown) is used to rotate the lens adjustment element 100 clockwise or counterclockwise about the pivot point inside an optical engine to realize a position adjustment of the lens 106. However, such design results in an unstable rotation pivot, and, during the process of the position adjustment of the lens 106, the entire lens adjustment element 100 is liable to undergo an off-centered rotation to result in inferior adjustment stability and low image qualities.

Among other conventional designs, Taiwan patent no. 1291039 has disclosed a lens adjustment apparatus, where a screw is used to control a rotation direction to adjust the position of a lens. However, according to the above design, the entire adjustment mechanism is needed to be formed on the back of the lens and thus fails to be used in a transmissive-type light-combination lens. Further, Taiwan patent no. 1330297 has disclosed an optical element adjustment device, where a reflector is mounted on a lens mount, a cone surface of an adjusting screw is in contact with the lens mount, and an elastic member is coupled to the lens mount. When the adjusting screw rotates on its axis, the reflector may correspondingly rotate about the axis.

### BRIEF SUMMARY OF THE INVENTION

The invention provides a lens position adjustment mechanism having a simplified configuration and suitable for different kinds of light-combination lenses with various types of incidence of light. The invention also provides an optical projection system having the lens position adjustment mechanism.

Other objects and advantages of the invention can be better understood from the technical characteristics disclosed by the invention.

In order to achieve one of the above purposes, all the purposes, or other purposes, one embodiment of the invention provides a lens position adjustment mechanism for adjusting a first light incident angle of a first light source relative to a light-combination lens and a second light incident angle of a second light source relative to the light-combination lens. The lens position adjustment mechanism includes a fixed cover, a lens mount, a force-exertion element, and a movable element. The fixed cover has at least one pivot hole and at least one fixed pillar. The lens mount accommodates the light-combination lens. A pivot part, a block part and a fastening part are formed on a side surface of the lens mount. The pivot part is inserted into the pivot hole of the fixed cover to allow the lens mount to pivot on the fixed cover. The force-exertion element is disposed on the pivot part, and two ends of the force-exertion element are respectively connected to the fixed pillar of the fixed cover and the fastening part of the lens mount to force the lens mount to rotate about the pivot part along a first rotation direction. The movable element is disposed on the fixed cover and pushes the block part to force the lens mount to rotate about the pivot part along a second rotation direction opposite the first rotation direction.

According to another embodiment of the invention, a lens position adjustment mechanism is used for adjusting a first light incident angle of a first light source relative to a light-combination lens and a second light incident angle of a second light source relative to the light-combination lens. The lens position adjustment mechanism includes a first fixed cover, a second fixed cover, a lens mount, a first force-exertion element, a second force-exertion element. The first fixed cover has at least one first pivot hole and at least one first fixed pillar and the second fixed cover has at least one second pivot hole and at least one second fixed pillar. The lens mount is confined between the first fixed cover and the second fixed cover and accommodates the light-combination lens. The lens mount has a first side surface and a second side surface opposite the first side surface. A first pivot part and a first fastening part are formed on the first side surface, and a second pivot part and a second fastening part are formed on the second side surface. The first pivot part is inserted into the first pivot hole and the second pivot part is inserted into the second pivot hole to allow the lamp mount to pivot on the first fixed cover and the second fixed cover. The first force-exertion element is disposed on the first pivot part, and two ends of the first force-exertion element are respectively connected to the first fixed pillar and the first fastening part to force the lens mount to rotate about the first pivot part along a first rotation direction. The second force-exertion element is disposed on the second pivot part, and two ends of the second force-exertion element are respectively connected to the second fixed pillar and the second fastening part to force the lens mount to rotate about the second pivot part along the first rotation direction. The lens position adjustment mechanism further includes a block part formed on at least one of the first side surface and the second side surface of the lens mount, and at least one movable element disposed on at least one of the first fixed cover and the second fixed cover. The movable element pushes the block part to force the lens mount to rotate about the first pivot part and the second pivot part along a second rotation direction opposite the first rotation direction.

According to another embodiment of the invention, an optical projection system includes at least one first light source and at least one second light source, a light-combination lens, a lens position adjustment mechanism, a light-homogenizing device, and an optical projection engine. The lens position adjustment mechanism is used to change a position of the light-combination lens so as to adjust a first light incident angle of a first light source relative to a light-combination lens and a second light incident angle of a second light source relative to the light-combination lens. The light-combination lens disposed on a light path of the first light beam and on a light path of the second light beam to combine the first light beam with the second light beam to form a combination beam. The light-homogenizing device receives and homogenizes the combination beam, and the optical projection engine converts the combination beam transmitted from the light-homogenizing device into an image beam and projects the image beam.

In one embodiment, the light-combination lens includes a transmissive region and a reflective region, the reflective region reflects the first light beam, and the transmissive region transmits the second light beam.

In one embodiment, the force-exertion element is a torsion spring or a spiral spring.

In one embodiment, the movable element includes a rotating screw, and the block part is pushed by operating the rotating screw.

In one embodiment, the lens position adjustment mechanism further includes at least one elastic piece engaging with the lens mount to secure the light-combination lens to the lens mount.

In one embodiment, the lens position adjustment mechanism further includes a fastening screw inserted into the pivot part of the lens mount to position the fixed cover.

In one embodiment, the lens mount is in a shape of a frame and the lens mount leans against a perimeter of the light-combination lens.

In conclusion, the embodiment or the embodiments of the invention may have at least one of the following advantages.

According to the above embodiments, simply by moving a movable element in one direction to push a lens mount, a fine adjustment to a position of a light-combination lens and to an angle of incidence of a light source is achieved. Therefore, errors in an output of a light source due to the manufacturing or assembly tolerance are finely corrected to achieve optimized image qualities. Accordingly, the lens position adjustment mechanism according to the above embodiments has a simplified configuration and reduced fabrication costs, and the operation to adjust the position of a light-combination lens is also simplified. In addition, since the lens mount may be in a shape of a frame to hold a perimeter of a light-combination lens, each component of a lens position adjustment mechanism does not block an incident light from a light source. Therefore, different kinds of light-combination lenses like reflective type, transmissive type, transflective type, etc are all suitable for the lens position adjustment mechanism according to the above embodiments.

Other objectives, features and advantages of the invention will be further understood from the further technical features disclosed by the embodiments of the invention wherein there are shown and described preferred embodiments of this invention, simply by way of illustration of modes best suited to carry out the invention.

### BRIEF DESCRIPTION OF THE DRAWINGS

FIG. 1 shows a schematic diagram of an optical projection system according to an embodiment of the invention.

FIG. 2 shows a schematic diagram of a light-combination lens according to an embodiment of the invention.

FIG. 3 shows an exploded diagram of a lens position adjustment mechanism according to an embodiment of the invention.

FIG. 4 shows a schematic diagram illustrating a lens position adjustment mechanism according to an embodiment of the invention.

FIG. 5 shows a schematic diagram illustrating an optical projection system according to another embodiment of the invention.

FIG. 6 shows a schematic diagram illustrating a conventional lens position adjustment mechanism.

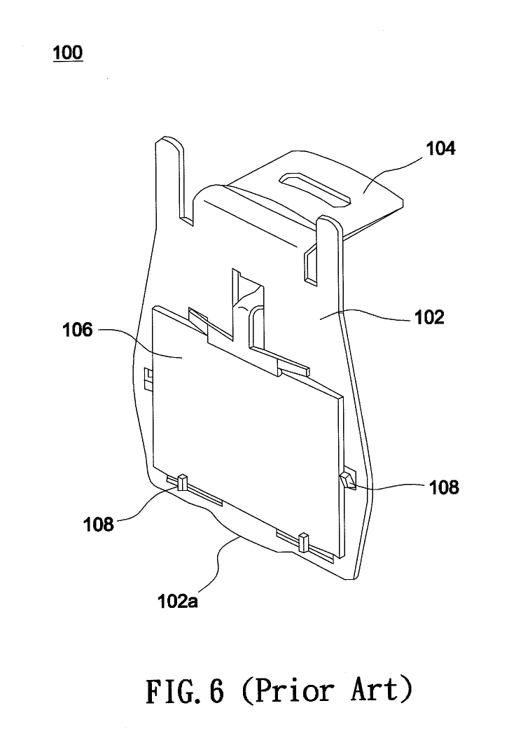

### DETAILED DESCRIPTION OF THE INVENTION

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

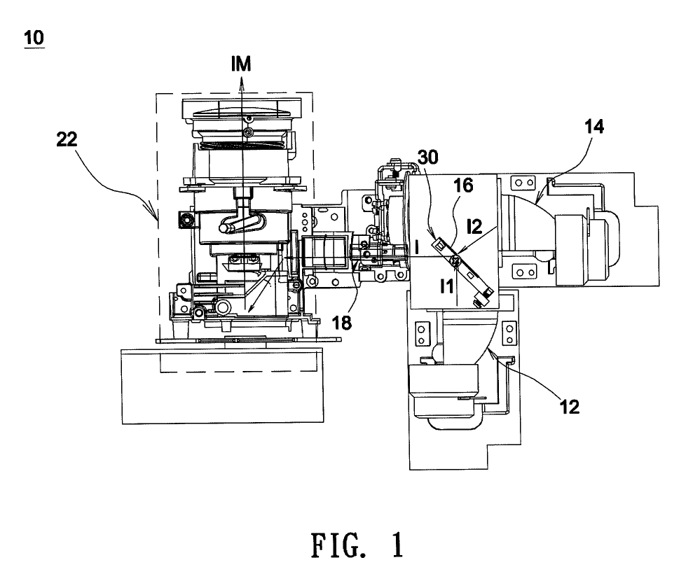

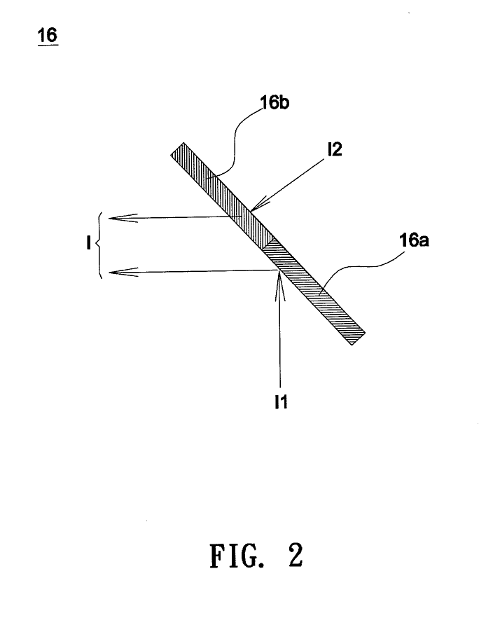

Referring to FIG. 1, an optical projection system 10 according to an embodiment of the invention includes a first light source 12 and a second light source 14 located in different positions, a light-combination lens 16, a light-homogenizing device 18, an optical projection engine 22 and a lens position adjustment mechanism 30. The first light source 12 emits a first light beam I1, and the second light source 14 emits a second light beam I2. The light-combination lens 16 is disposed on a light path of the first light beam I1 and on a light path of the second light beam I2. In one embodiment, the light-combination lens 16 reflects the first light beam I1 and transmits the second light beam I2 to form a combination beam I. For example, as shown in FIG. 2, the light-combination lens 16 is divided into two regions, where one region is coated with a light-reflection film 16a as a reflective region and the other is coated with a light-transmission film 16b as a transmissive region. The light-reflection film 16a reflects the first light beam I1, and the light-transmission film 16b transmits the second light beam I2, so that the first light beam I1 and the second light beam I2 are guided towards the same direction to form a combination beam I. Further, referring to FIG. 1, the light-homogenizing device 18 receives and homogenizes the combination beam I, and the optical projection engine 22 converts the combination beam I transmitted from the light-homogenizing device 18 into an image beam IM and projects the image beam IM.

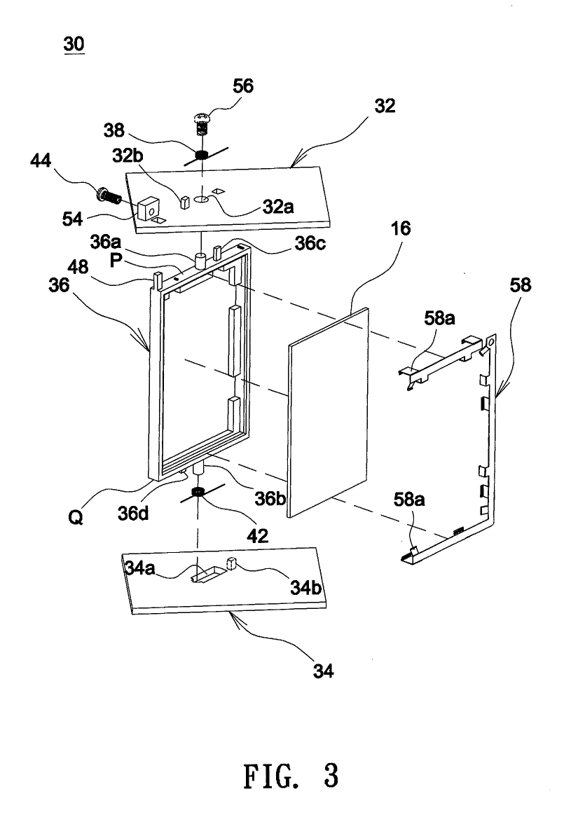

In an optical projection system, due to the manufacturing tolerance of a light bulb and variations in the assembly precision, light spots projected by different light source modules are formed on a light-combination lens at different positions. Therefore, as shown in FIG. 1, the lens position adjustment mechanism 30 used to change a position of the light-combination lens 16 may adjust a first light incident angle of the first light source 12 relative to the light-combination lens 16 and a second light incident angle of the second light source 14 relative to the light-combination lens 16. Accordingly, errors in the outputs of the first light source 12 and the second light source 14 are finely corrected to precisely direct the combination beam I into the optical projection engine 22 and thus achieve optimized image qualities. As shown in FIG. 3, a lens position adjustment mechanism 30 according to an embodiment of the invention includes a first fixed cover 32, a second fixed cover 34, a lens mount 36, a first force-exertion element 38, a second force-exertion element 42, and a movable element 44. The first fixed cover 32 has at least one first pivot hole 32a and at least one first fixed pillar 32b. The second fixed cover 34 has at least one second pivot hole 34a and at least one second fixed pillar 34b. The lens mount 36 is confined between the first fixed cover 32 and the second fixed cover 34 and accommodates the light-combination lens 16. In this embodiment, the lens mount 36 is in a shape of a frame, and, when the lens mount 36 accommodates the light-combination lens 16, the lens mount 36 leans against a perimeter of the light-combination lens 16. The lens mount 36 has a first side surface P and a second side surface Q opposite the first side surface P. A first pivot part 36a and a first fastening part 36c are formed on the first side surface P of the lens mount 36. A second pivot part 36b and a second fastening part 36d are formed on the second side surface Q of the lens mount 36. In addition, a block part 48 is formed on the first side surface P, and the movable element 44 is inserted into a base 54 disposed on the first fixed cover 32.

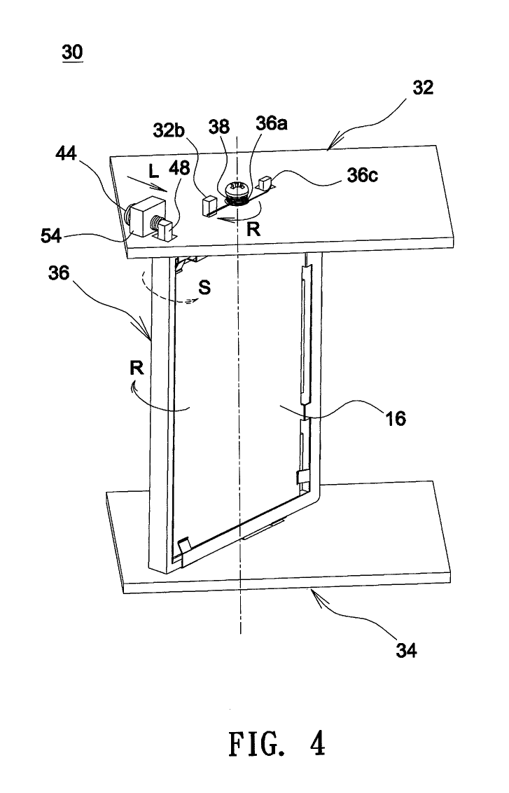

During assembly, first, the light-combination lens 16 is mounted on the lens mount 36 by an elastic piece stand 58. The elastic piece stand 58 includes at least one elastic piece 58a. When the lens mount 36 is wedged in the elastic piece 58a, the elastic piece 58a engages with one side of the lens mount 36 and abuts against the light-combination lens 16 to secure the light-combination lens 16 to the lens mount 36. The first pivot part 36a of the lens mount 36 is inserted into the first pivot hole 32a of the first fixed cover 32, and the second pivot part 36b of the lens mount 36 is inserted into the second pivot hole 34a of the second fixed cover 34 to allow the lens mount 36 to pivot on the first fixed cover 32 and the second fixed cover 34. In addition, a fastening screw 56 may be inserted into the first pivot part 36a of the lens mount 36 to position the first fixed cover 32. The first force-exertion element 38 is disposed on the first pivot part 36a, and two ends of the first force-exertion element 38 are respectively connected to the first fixed pillar 32b of the first fixed cover 32 and the first fastening part 36c of the lens mount 36. The second force-exertion element 42 is disposed on the second pivot part 36b, and two ends of the second force-exertion element 42 are respectively connected to the second fixed pillar 34b of the second fixed cover 34 and the second fastening part 36d of the lens mount 36. In one embodiment, each of the first force-exertion element 38 and the second force-exertion element 42 may include a torsion spring or a spiral spring. The center of the torsion spring or the spiral spring is coupled to a pivot part, and two ends of the torsion spring or the spiral spring are respectively connected to a fixed pillar on the fixed cover and a fastening part on the lens mount. As shown in FIG. 4, since two ends of the first force-exertion element 38 on the first pivot part 36a are respectively connected to the first fixed pillar 32b of the first fixed cover 32 and the first fastening part 36c of the lens mount 36, elastic forces exerted by the first force-exertion element 38 forces the lens mount 36 to rotate about the first pivot part 36a along a rotation direction R (for example, a clockwise direction shown in FIG. 4), and the lens mount 36 continually rotates along the rotation direction R until the block part 48 of the lens mount 36 leans against one side of the movable element 44. The movable element 44 is disposed on the first fixed cover 32 via the base 54, and the movable element 44 may be a rotating screw that can be operated to make a linear motion in a direction L. Therefore, the movable element 44 may move in the direction L to push the block part 48 and force the lens mount 36 to rotate about the first pivot part 36a along an opposite rotation direction S (for example, a counterclockwise direction shown in FIG. 4). Under the circumstance, by moving the movable element 44 in the direction L, the lens mount 36 is pushed to allow for a fine adjustment to the position of the light-combination lens 16. In addition, as shown in FIG. 3, the second force-exertion element 42 disposed on the second pivot part 36b similarly provides the elastic force to force the lens mount 36 to rotate about the second pivot part 36b along the rotation direction R.

Certainly, in case only one force-exertion element is sufficient to provide the elastic force to rotate the lens mount 36, and only one fixed cover is needed. In that case, the second fixed cover 34 and the second force-exertion element 42 may be omitted to further reduce the number of components and fabrication costs.

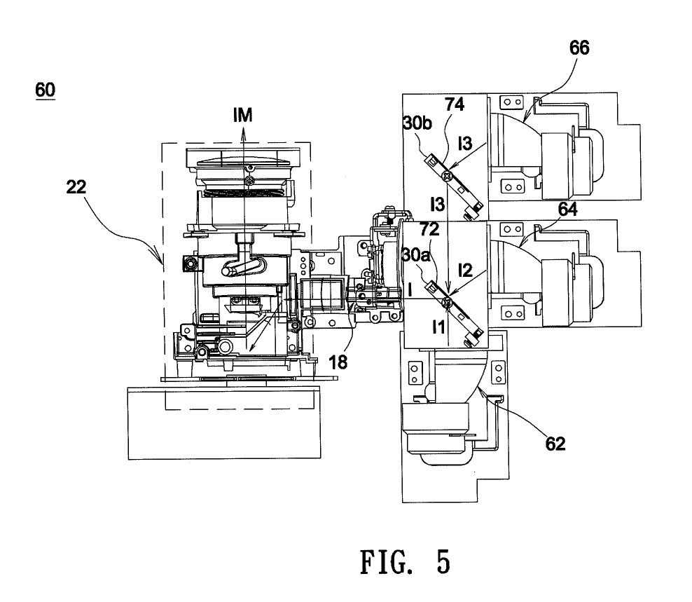

Further, the movable element 44 is not limited to a specific type, as long as the block part 48 is allowed to be pushed by the movable element 44 to rotate the lens mount 36. For example, the movable element 44 may be a rotating screw mentioned above, and the screw style can be arbitrarily selected to achieve a precise control of position adjustment. Alternatively, the movable element 44 may be a gear assembly. Moreover, the number of light sources in an optical projection system is not limited. For example, as shown in FIG. 5, an optical projection system 60 includes three light sources 62, 64, and 66 located in different positions, and two light-combination lenses 72 and 74 are used to combine light beams I1, I2, and I3 which are respectively emitted from the light sources 62, 64, and 66. Two lens position adjustment mechanisms 30a and 30b are used to respectively adjust the positions and angles of the light-combination lenses 72 and 74.

In conclusion, the lens position adjustment mechanism according to the embodiment or the embodiments of the invention may have at least one of the following advantages.

According to the above embodiments, simply by operating a movable element in one direction to push a lens mount, a fine adjustment to the position of a light-combination lens and to the angle of incidence of a light source is achieved. Therefore, errors in the output of a light source due to the manufacturing or assembly tolerance are finely corrected to achieve optimized image qualities. Accordingly, the lens position adjustment mechanism according to the above embodiments has a simplified configuration and reduced fabrication costs, and the operation to adjust the position of a light-combination lens is also simplified. In addition, since the lens mount may be in the shape of a frame to hold the perimeter of a light-combination lens, each component of a lens position adjustment mechanism does not block incident light of a light source. Therefore, different kinds of light-combination lenses like reflective type, transmissive type, transflective type, etc are all suitable for the lens position adjustment mechanism according to the above embodiments.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the invention as defined by the following claims. Moreover, no element and component in the present disclosure is intended to be dedicated to the public regardless of whether the element or component is explicitly recited in the following claims.

What is claimed is:

1. A lens position adjustment mechanism used for adjusting a first light incident angle of a first light source relative to a light-combination lens and adjusting a second light incident angle of a second light source relative to the light-combination lens, the lens position adjustment mechanism comprising:
a fixed cover having at least one pivot hole and at least one fixed pillar;
a lens mount for accommodating the light-combination lens, wherein a pivot part, a block part and at least one fastening part are formed on a side surface of the lens mount, and the pivot part is inserted into the pivot hole to allow the lens mount to pivot on the fixed cover;
a force-exertion element disposed on the pivot part, wherein two ends of the force-exertion element are respectively connected to the fixed pillar of the fixed cover and the fastening part of the lens mount to force the lens mount to rotate about the pivot part along a first rotation direction; and
a movable element disposed on the fixed cover and pushing the block part to force the lens mount to rotate about the pivot part along a second rotation direction opposite the first rotation direction.

2. The lens position adjustment mechanism as claimed in claim 1, wherein the force-exertion element is a torsion spring or a spiral spring.

3. The lens position adjustment mechanism as claimed in claim 1, wherein the movable element comprises a rotating screw and the block part is pushed by operating the rotating screw.

4. The lens position adjustment mechanism as claimed in claim 1, further comprising:
at least one elastic piece engaging with the lens mount to secure the light-combination lens to the lens mount.

5. The lens position adjustment mechanism as claimed in claim 1, further comprising:
a fastening screw inserted into the pivot part of the lens mount to position the fixed cover.

6. The lens position adjustment mechanism as claimed in claim 1, wherein the lens mount is in a shape of a frame and leans against a perimeter of the light-combination lens.

7. A lens position adjustment mechanism used for adjusting a first light incident angle of a first light source relative to a light-combination lens and a second light incident angle of a second light source relative to the light-combination lens, the lens position adjustment mechanism comprising:
a first fixed cover having at least one first pivot hole and at least one first fixed pillar;
a second fixed cover having at least one second pivot hole and at least one second fixed pillar;
a lens mount confined between the first fixed cover and the second fixed cover and accommodating the light-combination lens, wherein the lens mount has a first side surface and a second side surface opposite to each other, a first pivot part and a first fastening part are formed on the first side surface, a second pivot part and a second fastening part are formed on the second side surface, the first pivot part is inserted into the first pivot hole of the first fixed cover, and the second pivot part is inserted into the second pivot hole of the second fixed cover to allow the lens mount to pivot on the first fixed cover and the second fixed cover;
a first force-exertion element disposed on the first pivot part, wherein two ends of the first force-exertion element are respectively connected to the first fixed pillar and the first fastening part to force the lens mount to rotate about the first pivot part along a first rotation direction;
a second force-exertion element disposed on the second pivot part, wherein two ends of the second force-exertion element are respectively connected to the second fixed pillar and the second fastening part to force the lens mount to rotate about the second pivot part along the first rotation direction;
a block part formed on at least one of the first side surface and the second side surface of the lens mount; and
at least one movable element disposed on at least one of the first fixed cover and the second fixed cover and pushing the block part to force the lens mount to rotate about the first pivot part and the second pivot part along a second rotation direction opposite the first rotation direction.

8. An optical projection system, comprising:
at least one first light source and at least one second light source located in different positions, wherein the first light source emits a first light beam and the second light source emits a second light beam;
a light-combination lens disposed on a light path of the first light beam and on a light path of the second light beam to combine the first light beam with the second light beam to form a combination beam;
a lens position adjustment mechanism used to change a position of the light-combination lens, comprising:
at least one fixed cover having at least one pivot hole and at least one fixed pillar;
a lens mount for accommodating the light-combination lens, wherein a pivot part, a block part and at least one fastening part are formed on a side surface of the lens mount, and the pivot part is inserted into the pivot hole to allow the lens mount to pivot on the fixed cover;
a force-exertion element disposed on the pivot part, wherein two ends of the force-exertion element are respectively connected to the fixed pillar of the fixed cover and the fastening part of the lens mount to force the lens mount to rotate about the pivot part along a first rotation direction; and
a movable element disposed on the fixed cover and pushing the block part to force the lens mount to rotate about the pivot part along a second rotation direction opposite the first rotation direction;
a light-homogenizing device for receiving and homogenizing the combination beam; and
an optical projection engine for converting the combination beam transmitted from the light-homogenizing device into an image beam and projecting the image beam.

9. The optical projection system as claimed in claim 8, wherein the light-combination lens comprises a transmissive region and a reflective region, the reflective region reflects the first light beam, and the transmissive region transmits the second light beam.

10. The optical projection system as claimed in claim 8, wherein the force-exertion element is a torsion spring or a spiral spring.

11. The optical projection system as claimed in claim 8, wherein the movable element comprises a rotating screw and the block part is pushed by operating the rotating screw.

12. The optical projection system as claimed in claim 8, wherein the lens position adjustment mechanism further comprises:
at least one elastic piece engaging with the lens mount to secure the light-combination lens to the lens mount.

13. The optical projection system as claimed in claim 8, wherein the lens position adjustment mechanism further comprises:
a fastening screw inserted into the pivot part of the lens mount to position the fixed cover.

14. The optical projection system as claimed in claim 8, wherein the lens mount is in a shape of a frame and leans against a perimeter of the light-combination lens.
